(19) United States
(12) Patent Application Publication
(10) Pub. No.: US 2008/0212640 A1
(43) Pub. Date: Sep. 4, 2008

(54) APPARATUS AND METHOD FOR TESTING A TEMPERATURE MONITORING SUBSTRATE

(75) Inventors: Yasuharu Sasaki, Nirasaki-Shi (JP); Takehiro Ueda, Nirasaki-shi (JP); Taketoshi Okajo, Nirasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 12/020,317

(22) Filed: Jan. 25, 2008

Related U.S. Application Data
(60) Provisional application No. 60/911,651, filed on Apr. 13, 2007.

(30) Foreign Application Priority Data
Jan. 31, 2007 (JP) 2007-020768

(51) Int. Cl. G01K 13/02

(52) U.S. Cl. 374/100; 374/E13.006

(57) ABSTRACT

A testing apparatus for a temperature monitoring substrate includes a heat flow generating unit for generating a heat flow in the temperature monitoring substrate in a depthwise direction of the temperature sensors, wherein the temperature sensors are buried in the depthwise direction. Further, a testing method for a temperature monitoring substrate includes generating a heat flow in the temperature monitoring substrate in a depthwise direction, wherein the temperature sensors are buried in the depthwise direction; processing a temperature of the substrate measured by the temperature sensor under the heat flow by a prescribed method; and determining whether or not an error occurs in the temperature sensor.

### FIELD OF THE INVENTION

The present invention relates to an apparatus and a method for testing a temperature monitoring substrate to be used to measure a temperature and/or temperature distribution of a substrate in a semiconductor manufacturing process; and, more particularly, to an apparatus and a method for testing a temperature monitoring substrate that determines whether or not a temperature sensor is properly installed at the substrate.

### BACKGROUND OF THE INVENTION

During a semiconductor manufacturing process, a substrate, such as a silicon wafer, is subject to a heat treatment, such as oxidization, diffusion, or annealing. Usually, during the heat treatment, the substrate is heated in a furnace. At this time, since a temperature range varies according to the purposes of the heat treatment, it is necessary to monitor the temperature of the substrate to be heated in order that the furnace is maintained at a specific temperature or follows a preset rising or falling rate of temperature.

In order to monitor the temperature of the substrate, there is used a temperature monitoring substrate having a plurality of temperature sensors, for example, thermocouples, which are buried therein, and lead lines that extend from the temperature sensors. Therefore, it is important that the temperature of the substrate measured by the temperature monitoring substrate accurately follows the temperature of the substrate during a practical process. In this regard, manufacturers of such a temperature monitoring substrate are providing a correction table of temperature sensors therefor to guarantee the accuracy of measurement.

In general, a test for the temperature monitoring substrate by the manufacturer is performed by putting the temperature monitoring substrate in a thermostat bath at a known temperature, and testing whether or not the temperature sensors buried in the substrate accurately indicate the temperature of the thermostat bath.

Further, as a technique for adjusting the thermocouple, there is disclosed a method in Patent Document 1. According to this, an equithermal block is disposed in an electric furnace, and a heat radiation block is disposed above the equithermal block. Further, both blocks are connected to each other by a heat pipe to transfer heat therebetween, thereby making the temperature uniform over the equithermal block. Then, a thermocouple to be tested is inserted into an insertion hole formed in the equithermal block to adjust the thermocouple.

(Patent Document 1) Japanese Patent Application Publication No. 2001-74562

However, even though the manufacturers guarantee that the temperature monitoring substrates are accurately adjusted, a noticeable number of temperature monitoring substrates still output erroneous values during an actual semiconductor manufacturing process.

The reason why the temperature monitoring substrate output such erroneous values is as follows. The manufacturer performs the adjustment of the temperature sensor by putting the temperature monitoring substrate in the thermostat bath, and determining whether or not the temperature in the thermostat bath is consistent with the temperature measured by the temperature sensor buried in the substrate. In this case, an abnormality of the temperature sensor itself can be detected. However, an abnormality due to an improper installation of the temperature sensor to the substrate cannot be detected by such a method.

The improper installation of the temperature sensor may adversely affect the temperature measurement of the substrate during an actual semiconductor manufacturing process. The reason thereof will be described with reference to FIGS. 5 and 6. FIG. 5 is a diagram illustrating a method of installing a thermocouple to a semiconductor substrate. FIG. 6 is a diagram illustrating the reason why an error occurs in measuring a temperature of a substrate when a temperature sensor is improperly installed.

As shown in FIG. 5, the installation of a thermocouple to a substrate is usually performed by forming an insertion hole 2 in a substrate 1, inserting a contact 3 of a thermocouple into the insertion hole 2 to a specific depth, and filling the insertion hole 2 with an adhesive 4, thereby adhering and fixing the thermocouple to the substrate. The fluidity of the adhesive 4 filled in the insertion hole 2 is inversely proportional to the heat resistance thereof.

Therefore, if the adhesive 4 has a higher heat resistance to increase the heat resistance, the fluidity is deteriorated. Then, the air in the insertion hole 2 is less likely to be discharged to the outside, so that a residual bubble 5 is generated around the contact 3. The residual bubble 5 is mainly generated below the contact 3, which causes an error in the temperature measurement value during an actual process.

A processing of the semiconductor substrate, such as a plasma treatment, is often accompanied with heat transfer. That is, as shown in FIG. 6, a heat source 6 is provided above the substrate 1, and a cooling mechanism 8 is provided in a substrate mounting table (wafer chuck) 7. With this structure, a heat flow is generated in the substrate 1, and a temperature gradient is formed in the depthwise direction of the substrate 1.

More specifically, the temperature of an upper surface of the substrate is T₁, the temperature of a lower surface of the substrate T₂, and the temperature of the substrate at the position where the contact 3 is located is Tₘ. Therefore, if the residual bubble 5 is formed as shown in FIG. 5, the thermal conductivity is remarkably reduced at that portion. Accordingly, a heat flow moving from the top to the contact 3 is blocked by the residual bubble 5, and rarely reaches the bottom. Further, a heat transfer from the cooling mechanism 8 is not sufficiently conducted.

Therefore, during an actual process, the temperature T₃ of the contact 3 becomes higher than the temperature of the wafer (which means the substrate temperature Tₘ at the depth of the contact 3). Thus, since the temperature of the temperature monitoring substrate is not approximately equal to the wafer temperature during the actual process, the temperature monitoring substrate cannot function properly. Further, the same problem also occurs if a foreign substance having a low thermal conductivity exists in place of the residual bubble 5.

As described above, an error caused by an abnormality in an electromotive force of the thermocouple can be detected according to the conventional method of adjusting the temperature monitoring substrate by using the thermostat bath. However, an error in the temperature measurement value caused by the improper installation (hereinafter, simply referred to as “installation failure”) cannot be detected by the conventional method. This is because of the property of the thermostat bath. In case of the thermostat bath, the temperature in the vicinity of the contact of the thermocouple is the same. Therefore, even if a residual bubble or a foreign substance exists as described above, the temperature at the contact rapidly becomes equal to the substrate temperature therearound, thereby making it difficult to detect an installation failure.

The installation failure (a measurement error caused by the residual bubble or the foreign substance) needs to be detected by a nondestructive testing. One of the nondestructive testing methods is detecting a bubble or a foreign substance by X-ray fluoroscopy. However, since this method requires excessive costs and time, it is not practical.

### SUMMARY OF THE INVENTION

In view of the foregoing, the invention provides a practical technology that can easily and reliably detect in a nondestructive manner whether or not a residual bubble or a foreign substance, which may cause an error in measuring the temperature, exists at a portion of a temperature monitoring substrate where a temperature sensor is located, without using a large-scale apparatus such as an X-ray apparatus.

The inventors have studied various technologies to solve the above-described problem, and have found that an installation failure of a temperature sensor can be easily detected by comparing measurement values of at least two thermocouples installed at the same depth, wherein the measurement is performed in a state where a uniform heat flow or temperature distribution is formed in a depthwise direction of a substrate.

In accordance with one aspect of the present invention, there is provided a testing apparatus for a temperature monitoring substrate that monitors a temperature and/or a temperature distribution of the substrate by using one or more temperature sensors buried in the substrate, the testing apparatus including a heat flow generating unit for generating a heat flow in the temperature monitoring substrate in a depthwise direction of the temperature sensors, wherein the temperature sensors are buried in the depthwise direction.

It is preferable that the heat flow generating unit includes a heating source provided on one surface of the temperature monitoring substrate; and a heat sink provided at the other surface opposite to said one surface.

In the testing apparatus, the heating source may be a heat source that generates radiant heat, and the heat sink may be a cooling block in which a coolant circulates.

Further, it is possible that the heating source and the heat sink are configured to generate the heat flow in and around only one of the temperature sensors, and the testing apparatus further includes a transfer unit that moves the temperature monitoring substrate in parallel to the heating source and the heat sink to generate the heat flow in and around all of the temperature sensors sequentially.

If a diameter of the temperature monitoring substrate is large, it is not always easy to configure the heating source and the heat sink such that a uniform heat flow is formed over the entire surface of the substrate. In many cases, there occurs a difference of heat flow between a central portion and a peripheral portion of the substrate, thereby causing the temperature to vary according to the location even when the depths of the thermocouples are the same.

In this regard, by generating the heat flow only in the regions in and around the temperature sensors, the condition of constant heat flow can be satisfied more easily. Therefore, by shifting the substrate using the transfer unit such that the thermocouples enter the above-mentioned regions one after another, it becomes easier to test the measurement values of the thermocouples under the condition of constant heat flow.

It is possible to determine whether or not an error has occurred in the temperature sensor by comparing one or more temperature values of the substrate measured by the temperature sensors under the heat flow with a preset temperature.

Further, it is also possible to determine whether or not an error has occurred in each of the temperature sensors by comparing temperature values of the substrate measured by the temperature sensors under the heat flow with each other, wherein the temperature sensors are buried in the same substrate.

Further, it is also possible to calculate a deviation of measured temperature of each of the temperature sensors from the temperature values of the substrate measured by the temperature sensors, and determine that an error has occurred in one of the temperature sensors if the deviation exceeds a specific level at said one of the temperature sensors.

In accordance with another aspect of the present invention, there is provided a testing method for a temperature monitoring substrate that monitors a temperature and/or a temperature distribution of the substrate by using one or more temperature sensors buried in the substrate, the testing method including the steps of generating a heat flow in the temperature monitoring substrate in a depthwise direction, wherein the temperature sensors are buried in the depthwise direction; processing one or more temperature values of the substrate measured by the temperature sensors under the heat flow according to a specific procedure; and determining whether or not an error has occurred in the temperature sensor.

In the testing method, it is possible to determine whether or not an error has occurred in the temperature sensors depending on whether or not the temperature values of the substrate measured by the temperature sensor fall within a preset temperature range.

Further, it is also possible to determine whether or not an error has occurred in each of the temperature sensors by comparing the temperature values of the substrate measured by the temperature sensors with each other, wherein the temperature sensors are buried in the same substrate.

Further, it is also possible to calculate a deviation of temperature values of the substrate measured by the temperature sensors for determining whether or not an error has occurred in one of the temperature sensors depending on whether or not the deviation exceeds a specific level at said one of the temperature sensors.

In accordance with the present invention, it can easily and reliably detected in a nondestructive manner whether or not a residual bubble or a foreign substance, which may cause an error in measuring the temperature, exists at a portion of a temperature monitoring substrate where a temperature sensor is located, without using a large-scale apparatus such as an X-ray apparatus.

### BRIEF DESCRIPTION OF THE DRAWINGS

The above objects of the present invention will become apparent from the following description of embodiment given in conjunction with the accompanying drawings, in which:

FIG. 1 is a schematic cross-sectional view of a testing apparatus for a temperature monitoring substrate in accordance with a first embodiment of the invention;

FIG. 2 is a schematic cross-sectional view of a testing apparatus for a temperature monitoring substrate in accordance with a second embodiment of the invention;

FIG. 3 is a diagram for comparing measurement values of a substrate temperature during a heat flow test (testing apparatus) to those during an actual process in accordance with the embodiment;

FIGS. 4A to 4D are X-ray fluoroscopic images and diagrams showing locations of thermocouples in accordance with the embodiment;

FIG. 5 is an explanatory view illustrating a method of installing a thermocouple to a semiconductor substrate; and

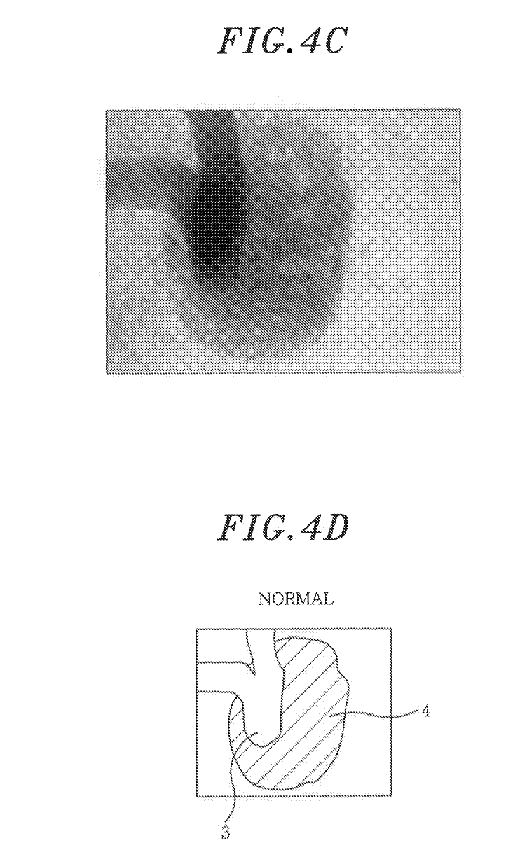

FIG. 6 is an explanatory view illustrating the reason why an error occurs in measuring a temperature using a temperature monitoring substrate.

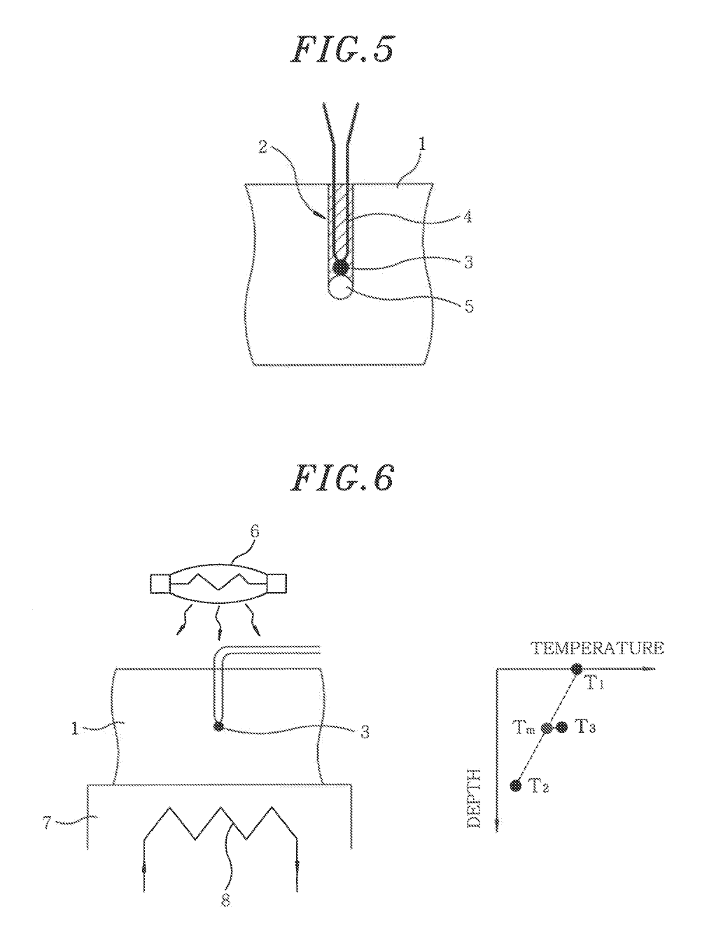

### DETAILED DESCRIPTION OF THE EMBODIMENT

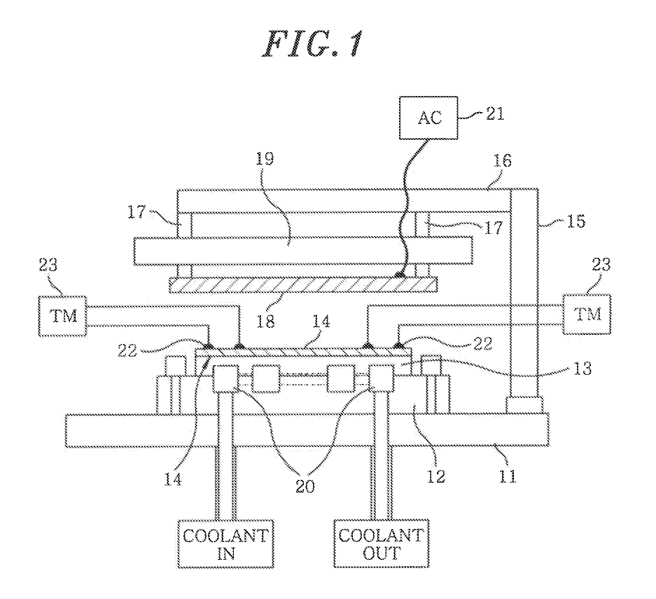

FIG. 1 is a schematic cross-sectional view of a testing apparatus for testing a temperature monitoring substrate in accordance with a first embodiment of the invention. In this testing apparatus, a cooling block 12 is disposed on a base 11, and a mounting table 13 is disposed on the cooling block 12. A temperature monitoring substrate 14 is mounted on the mounting table 13. A column 15 is disposed to be supported by the base 11, and a plate-shaped radiant heat source 18 is connected to the column 15 by an arm 16 and a support member 17 so as to cover almost the entire top surface of the substrate 14. A reflecting plate 19 is provided to face an upper surface of the radiant heat source 18 such that heat radiated from the radiant heat source 18 is more efficiently irradiated onto the substrate 14.

The cooling block 12 and the mounting table 13 are formed as a united body to serve as a heat sink. A coolant path 20 is formed in the cooling block 12 and the mounting table 13 such that almost the entire surface of the substrate 14 mounted on the mounting table 13 is cooled by thermal conduction. With the radiant heat source 18 and the heat sink, a substantially uniform heat flow is generated over the entire substrate 14.

As the radiant heat source 18, it is preferable to use one having a thermally conductive wire at a rear surface of a radiation body such as a ceramic plate or a carbon plate that radiates an infrared ray when powered by a power supply 21. The mounting table 13 is usable if only it supports the substrate horizontally. For example, an electrostatic chuck that adsorbs and holds the substrate may be used as the mounting table 13. In case of using the electrostatic chuck as the mounting table 13, the adhesion between the mounting table 13 and the substrate 14 is increased, so that the thermal resistance at an interface therebetween is reduced to thereby stabilize the heat radiation.

In the testing apparatus in accordance with this embodiment, a uniform heat flow is formed over the entire surface of the substrate 14. Therefore, by having a thermometer 23 indicate or record an electromotive force of each of thermocouples 22 installed at the temperature monitoring substrate 14, all of the thermocouples can be tested at the same time.

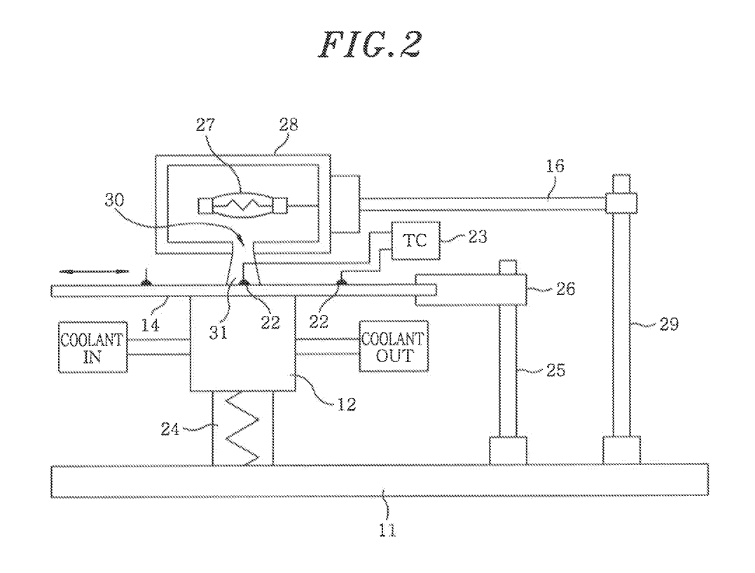

FIG. 2 is a schematic cross-sectional view of a testing apparatus for a temperature monitoring substrate in accordance with another embodiment of the invention. In this testing apparatus, a cooling block 12 is installed over a base 11 via a spring pedestal 24 interposed therebetween, and a temperature monitoring substrate 14 is mounted on the cooling block 12. The temperature monitoring substrate 14 is held by a substrate moving mechanism 26 fixed to a first column 25 so as to move in a direction parallel to the main surface. Herein, the cooling block 12 is supported independently from the substrate 14 such that the cooling block 12 is forced upward by the spring pedestal 24 to come into tight contact with the substrate 14.

Meanwhile, a heating source includes a heating box 28 that has an infrared lamp 27 therein. The heating box 28 is supported by a second column 29 and an arm 16. The heating box 28 is provided with a heat radiation hole 30 at the center of its lower surface so that an infrared ray radiated from the heat radiation hole 30 is irradiated onto the substrate 14. A portion onto which the infrared ray is irradiated is a heating region 31. The heat transferred to a part of the substrate located at the heating region is then cooled by the cooling block 12 functioning as a heat sink, so that a heat flow is generated in the substrate.

The testing apparatus in accordance with this embodiment measures only such thermocouple(s) 22 located in the heating region 31. The measurement may be performed by sequentially shifting the substrate in a horizontal direction by the transfer mechanism 26 such that the thermocouples installed at the substrate 14 reach the center of the heating region 31 one after another. In this manner, the temperature measurement values can be obtained under the same heat flow condition for all the thermocouples. According to this method, a large amount of time is required for the temperature measurement compared to the method of FIG. 1, but it becomes easier to equalize the heat flow condition for all the thermocouples so that a more accurate measurement can be achieved.

In this testing apparatus, the heat source is not limited to a lamp heater, but any device may be used insofar as it emits radiant heat. Further, the cooling block may be configured to flow a coolant into an internal flow passage, or may also be configured to make use of the Peltier effect. Further, instead of such method of generating heat flow, it is possible to employ other methods such as one that sprays a high-temperature fluid to a heat source and a low-temperature fluid to a heat sink.

Furthermore, the environment of the measurement may be in the air or in the vacuum. Further, the transfer mechanism 26 is not limited to an automatic mechanism using a mechanical force, but may also be of a manual type that uses a manual input force. In short, any configuration will do as long as the transfer mechanism can move the substrate in the horizontal direction such that each of the thermocouples can be placed at a specific location in the heating region to be maintained at that location during the temperature measurement.

Hereinafter will be described a method of detecting an installation failure of the thermocouples (which causes an error in the temperature measurement value due to a bubble or a foreign substance) based on the temperature measurement value of the thermocouples installed at the object to be tested in accordance with the present invention.

First, the apparatus shown in FIG. 1 or 2 is used to obtain N number of temperature measurement data T₁, T₂, . . . , and T_{N} for the respective thermocouples located at a substantially same depth while a heat flow exists. Then, an average and a deviation of the measurement data under a constant heat flow are obtained from the measurement data. For convenience, this measurement will be referred to as “preliminary measurement” hereinafter. In the preliminary measurement, the deviation of the measurement data includes a measurement error of each measurement (due to individual differences between the thermocouples and the limited reproducibility of the measurement system), an error in the amount of heat generated by the heating source, an error in the amount of heat absorbed by the heat sink, and, if any, an installation failure of the object to be measured (which is the primary object of this measurement).

The deviation due to the errors can be eliminated as follows. The individual differences between the measurement values indicated by the thermocouples are usually about ±2.5° C. However, if the measurement values are measured in advance for the individual thermocouples by performing thermostat bath tests, the measurement is no longer affected by the individual differences, and only the reproducibility needs to be taken into consideration.

Further, if a previously used measurement system is reused under the conditions of a temperature-controlled environment, a rule-regulated compensation wire, a correction-completed amplifier and the like, most errors can be eliminated. In addition, the amount of heat generated by the heating source or absorbed by the heat sink can be controlled to be constant by properly adjusting such physical quantities as the current and the voltage during the resistance heating, the temperature and the flow rate of the coolant during the cooling and the like.

Under the above-described environment, an installation failure is determined as follows. In this measurement system, if an installation failure exists, the temperature involved therewith becomes higher than in the normal case. Therefore, under the same measurement conditions, the temperature deviation at a measurement point having the lowest temperature indicates a degree of installation failure. Further, the measured temperature is affected by the environment temperature, the amount of heat radiation and the amount of heat absorption. Therefore, it is important to confirm that the temperature at the measurement point having the lowest temperature is not less than a lower limit value for measurement validity (which value is determined on the basis of, e.g., the average temperature in the preliminary measurement) for ensuring that the temperature is measured under a sufficient heat flow.

Thus, a criterion for determining that there is no installation failure is set as follows: a temperature deviation at a measurement point having the lowest temperature among a plurality of measurement points measured under the same measurement condition is equal to or higher than 0° C. and is equal to or less than a threshold value, and the temperature at the measurement point having the lowest temperature exceeds the lower limit value for measurement validity obtained in the preliminary measurement. By using the criterion as above, it is possible to determine whether or not there is an installation failure.

Due to the nature of the measurement, a more intense heat flow makes the deviation from the lowest temperature increase to allow a higher resolution in the determination. From experience, in an environment where the temperature at the point where the lowest temperature is measured is within +3° C. from a reference temperature, the standard for a non-defective product requires the condition ΔT=+0.2° C. In addition, in an environment where the temperature at the point where the lowest temperature is measured is within +6° C. from the reference temperature, the condition ΔT=+0.4° C. is required.

### FIRST EXAMPLE

Using the testing apparatus shown in FIG. 2, temperature measurement was performed on a temperature monitoring substrate to which four thermocouples are installed. Then, while maintaining the substrate in an actual plasma processing apparatus, a temperature measurement was performed during an actual process in which plasma was generated. Subsequently, the temperature indicated by the testing apparatus was compared to the temperature during the actual process. In addition, the deviation of the indicated values of the thermocouples was measured while maintaining the substrate in the thermostat bath. The temperature monitoring substrate to be measured had a diameter of 300 mm and a thickness of 725 μm, and K thermocouples were used. Furthermore, the K thermocouples were arranged at locations distanced from the center by a radius 142 mm and shifted from each other at a degree of 90°, and the K thermocouples were installed at the same depth.

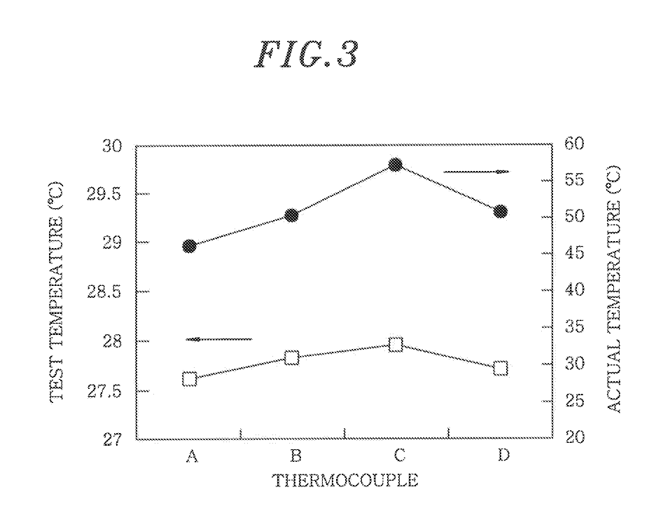

The measurement results are shown in Table 1, and the comparison between the temperature measurement values during the heat flow test and the actual process is shown in FIG. 3. First, it can be seen that the temperature in the thermostat bath was within a range from 101.3 to 101.4° C., and there was no error in the electromotive force of the thermocouples used for the measurement. The temperature during the heat flow test was within a range from 27.6 to 27.95° C., and the temperature during the practical process was within a range from 46.4 to 57.35° C. During the actual process, the temperature was higher and the deviation was larger. However, it can be seen that the temperature during the heat flow test has an approximately linear relationship with that during the actual use.

TABLE 1

| | Thermostat temperature | | |
|---|---|---|---|
| | (100° C. in case of | During heat | During |
| Sensor | conventional correction) | flow test | actual use |
| A | 101.4° C. | 27.6° C. | 46.4° C. |
| B | 101.4° C. | 27.82° C. | 50.45° C. |
| C | 101.3° C. | 27.95° C. | 57.35° C. |
| D | 101.3° C. | 27.74° C. | 50.8° C. |

### SECOND EXAMPLE

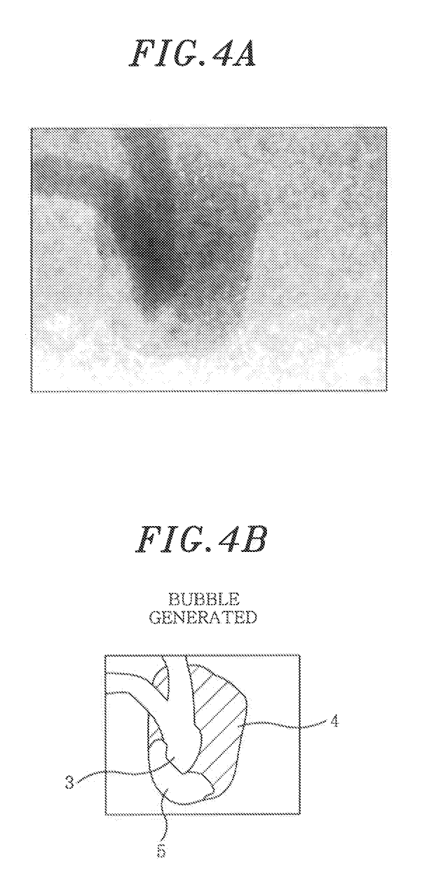

In the same manner as the first example, a heat flow measurement was performed by the testing apparatus. Then a location of a thermocouple determined to have an installation failure and a location of another thermocouple determined not to have an installation failure were observed by X-ray fluoroscopy. At the thermocouple that was determined to be improperly installed, ΔT (the deviation from the average temperature) was 0.22° C. However, at the thermocouple that was determined to be properly installed, ΔT was 0.16° C. X-ray fluoroscopic images were obtained by obliquely irradiating an X ray onto the substrate at approximately 30° (an inclination degree of 60° with respect to the normal), and diagrams thereof were presented below the photographs, respectively. The X-ray fluoroscopic images and the diagrams thereof are shown in FIG. 4A to FIG. 4D.

FIGS. 4C and 4D show a case where the thermocouple is properly installed (no installation failure), and FIGS. 4A and 4B show a case where a bubble exists below the thermocouple. Specifically, in case of FIGS. 4C and 4D, the adhesive 4 is filled up around the contact 3 of the thermocouple as illustrated in FIG. 4D, and the X-ray image is uniform and does not have a luminance blur. However, in case FIGS. 4A and 4B, a high-luminance portion is formed at a part of the adhesive 4 below the contact 3, and this portion is thought to be the residual bubble 5. From these results, it can be seen that ΔT is higher when the residual bubble exists. Therefore, it has been confirmed that an installation failure can be determined by using the method in accordance with the embodiment of the invention.

While the invention has been shown and described with respect to the embodiment, it will be understood by those skilled in the art that various changes and modifications may be made without departing from the scope of the invention as defined in the following claims.

What is claimed is:

1. A testing apparatus for a temperature monitoring substrate that monitors a temperature and/or a temperature distribution of the substrate by using one or more temperature sensors buried in the substrate, the testing apparatus comprising:
a heat flow generating unit for generating a heat flow in the temperature monitoring substrate in a depthwise direction of the temperature sensors, wherein the temperature sensors are buried in the depthwise direction.

2. The testing apparatus of claim 1, wherein the heat flow generating unit includes:
a heating source provided on one surface of the temperature monitoring substrate; and
a heat sink provided at the other surface opposite to said one surface.

3. The testing apparatus of claim 2, wherein the heating source is a heat source that generates radiant heat, and the heat sink is a cooling block in which a coolant circulates.

4. The testing apparatus of claim 1, wherein the heating source and the heat sink are configured to generate the heat flow in and around only one of the temperature sensors, the testing apparatus further comprising:
a transfer unit that moves the temperature monitoring substrate in parallel to the heating source and the heat sink to generate the heat flow in and around all of the temperature sensors sequentially.

5. The testing apparatus of claim 1, further comprising:
a determination unit that compares one or more temperature values of the substrate measured by the temperature sensors under the heat flow with a preset temperature to determine whether or not an error has occurred in the temperature sensor.

6. The testing apparatus of claim 1, further comprising:
a determination unit that compares temperature values of the substrate measured by the temperature sensors under the heat flow with each other to determine whether or not an error has occurred in each of the temperature sensors, wherein the temperature sensors are buried in the same substrate.

7. The testing apparatus of claim 1, further comprising:
a determination unit that calculates a deviation of temperature values of the substrate measured by the temperature sensors under the heat flow, and determines that an error has occurred in one of the temperature sensors if the deviation exceeds a specific level at said one of the temperature sensors, wherein the temperature sensors are buried in the same substrate.

8. A testing method for a temperature monitoring substrate that monitors a temperature and/or a temperature distribution of the substrate by using one or more temperature sensors buried in the substrate, the testing method comprising:
generating a heat flow in the temperature monitoring substrate in a depthwise direction, wherein the temperature sensors are buried in the depthwise direction;
processing one or more temperature values of the substrate measured by the temperature sensors under the heat flow according to a specific procedure; and
determining whether or not an error has occurred in the temperature sensor.

9. The testing method of claim 8, wherein it is determined whether or not an error has occurred in the temperature sensors depending on whether or not the temperature values of the substrate measured by the temperature sensor fall within a preset temperature range.

10. The testing method of claim 8, wherein it is determined whether or not an error has occurred in each of the temperature sensors by comparing the temperature values of the substrate measured by the temperature sensors with each other, wherein the temperature sensors are buried in the same substrate.

11. The testing method of claim 8, wherein a deviation of measured temperature of each of the temperature sensors is calculated from the temperature values of the substrate measured by the temperature sensors, and it is determined whether or not an error has occurred in one of the temperature sensors depending on whether or not the deviation exceeds a specific level at said one of the temperature sensors.
